(19) United States
(12) Patent Application Publication
(10) Pub. No.: US 2018/0301170 A1
(43) Pub. Date: Oct. 18, 2018

(54) Computer-Implemented Methods to Share Audios and Videos

(71) Applicant: Iman Rezanezhad Gatabi, Grand Forks, ND (US)

(72) Inventor: Iman Rezanezhad Gatabi, Grand Forks, ND (US)

(21) Appl. No.: 16/011,466

(22) Filed: Jun. 18, 2018

Related U.S. Application Data
(60) Provisional application No. 62/622,870, filed on Jan. 27, 2018.

(51) Int. Cl. G11B 27/036; H04N 5/93; G11B 27/34

(52) U.S. Cl. CPC G11B 27/036; G06F 17/28; G11B 27/34; H04N 5/9305

(57) ABSTRACT

This application discloses computer-implemented methods to share videos or audios between users, wherein a first user shares a video or an audio, wherein a second user or a computer-implemented algorithm enters an annotation or a voice, wherein the said second user or the said algorithm assigns a time interval to the said annotation or voice or to a modified version of the said annotation or voice, wherein a user or a computer-implemented algorithm can elect that the said annotation or voice or a modified version of the said annotation or voice be displayed or played during a time interval of the said audio or video or a modified version of the said audio or video. In some example implementations of the invention, said annotation or voice is a translation of a voice of the said video or audio during the said time interval of the said audio or video or a modified version of the said audio or video.

### CROSS-REFERENCE TO RELATED APPLICATIONS

This application claims the benefits of U.S. provisional application Ser. No. 62/622,870, filed on Jan. 27, 2018.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Sharing audios and videos between users of computers and computer-based devices are becoming more and more popular nowadays. With more people having access to internet, video and audio sharing websites and apps are widely used by different users. One of such websites is youtube.com through which users can upload videos and share them with other users on the internet.

One of the issues associated with the said websites and other computer-based video or audio sharing platforms is that many users subscribed to such websites or platforms do not understand the language of every shared video or audio. As a result, they may not understand the content of a video or an audio shared by another user. For example, if user A shares a video in French language on YouTube, user B who only understands Farsi and does not understand French may not be able to understand the content of the said video shared by user A. Therefore, there is a need to improve video and audio sharing websites and platforms so that the shared audio and videos can be viewed and be understood by more users.

### BRIEF SUMMARY OF THE INVENTION

Several computer-implemented methods will be described herein which may be implemented to provide annotations or translations of a part of a shared video or a shared audio. Implementations of the present invention may enable the said shared video or shared audio to be understood and viewed by a larger number of users.

This application discloses computer-implemented methods to share videos or audios between users, wherein a first user shares a video or an audio, wherein a second user or a computer-implemented algorithm enters an annotation or a voice, wherein the said second user or the said algorithm assigns a time interval to the said annotation or voice or to a modified version of the said annotation or voice, wherein a user or a computer-implemented algorithm can elect that the said annotation or voice or a modified version of the said annotation or voice be displayed or played during a time interval of the said audio or video or a modified version of the said audio or video. In some example implementations of the invention, said annotation or voice or a modified version of the said annotation or voice is a translation of a voice of the said video or audio during the said time interval of the said audio or video or a modified version of the said audio or video.

### BRIEF DESCRIPTION OF THE SEVERAL VIEWS OF THE DRAWING

FIG. 1 shows a prior art where it depicts steps of a method in which a user can add an annotation to a video and share the resulting video with subtitle on YouTube.

FIG. 2 shows an example implementation of the invention where it depicts steps of a method in which a user shares a video on a video sharing website and another user enters an annotation to the said website and assigns a time interval to the said annotation.

FIG. 3A depicts a view of an example implementation of the invention where it shows a video sharing website in an interne browser window as it is viewed by a user of the said video sharing web site.

FIG. 3B shows a view of an example implementation of the invention in which a user can enter an annotation and/or an annotation title and assign a time interval to the said annotation.

FIG. 3C shows a view of an example implementation of the invention in which a user can elect to display or to not display a previously-entered annotation.

FIG. 3D shows a view of an example implementation of the invention in which an annotation is displayed as a subtitle of a video.

FIG. 3E illustrates a view of an example implementation of the invention in which an annotation is displayed in an area of a display other than the video window.

FIG. 3F shows a view of an example implementation of the invention in which a modified annotation derived from an annotation entered by a user is displayed as a subtitle of a video.

FIG. 4 shows an example implementation of the invention where it depicts steps of a method in which a user shares a video on a video sharing website and another user records a voice and assigns a specific time interval to the said voice.

### DETAILED DESCRIPTION OF THE INVENTION

Different examples will be described in details that represent some example implementations of the present invention. While the technical descriptions presented herein are representatives for the purposes of describing the present invention, the present invention may be implemented in many alternate forms and should not be limited to the examples described herein.

The described examples can be modified in various alternative forms. For example, the thickness and dimensions of the regions in drawings may be exaggerated for clarity. Unless otherwise stated, there is no intention to limit the invention to the particular forms disclosed herein. However, examples are used to describe the present invention and to cover some modifications or alternatives within the scopes of the invention.

The spatially relative terms which may be used in this document such as “underneath”, “below” and “above” are for the ease of description and to show the relationship between an element and another one in the figures. If the device in the figure is turned over, elements described as “underneath” or “below” other elements would then be “above” other elements. Therefore, for example, the term “underneath” can represent an orientation which is below as well as above. If the device is rotated, the spatially relative terms used herein should be interpreted accordingly.

Unless otherwise stated, the terms used herein have the same meanings as commonly understood by someone with ordinary skills in the invention field. It should be understood that the provided example implementations of the present invention may just have features or illustrations that are mainly intended to show the scope of the invention and different designs of other sections of the presented example implementations are expected.

Throughout this document, the whole structure or an entire drawing of the provided example implementations may not be presented for the sake of simplicity. This can be understood by someone with ordinary expertise in the field of invention. For example, when showing a window of a website, we may just show an address box and a search box, and do not show the buttons to maximize and minimize the said window. In such cases, any new or well-known designs or implementations for the un-shown parts are expected. Therefore, it should be understood that the provided example implementations may just have illustrations that are mainly intended to depict a scope of the present invention and different designs and implementations of other parts of the presented example implementations are expected.

This application discloses computer-implemented methods to share videos between users, wherein a first user shares a video, wherein a second user or a computer-implemented algorithm enters an annotation, wherein the said second user or the said algorithm assigns a time interval to the said annotation or to a modified version of the said annotation. In some example implementations of the invention, the said annotation or a modified version of the said annotation is displayed as a sub-title of the said video or a modified version of the said video during an entire or a part of the said time interval of the said video or the said modified version of the said video. In some example implementations of the invention, the said annotation or a modified version of the said annotation is displayed during a time interval (which may be different from the said assigned time interval) of the said video or a modified version of the said video. In some example implementations, the said annotation or a modified version of the said annotation is displayed in an area of a display other than the video area during the said assigned time interval or a different time interval of the said video or a modified version of the said video. In some example implementations, the said annotation or the said modified version of the said annotation is a translation of a voice of the said video during an entire or a part of the said time interval of the said video or a modified version of the said video. In some example implementations, the said annotation or the said modified version of the said annotation is a text of a voice of the said video or a modified version of the said video during an entire or a part of the said time interval of the said video or the said modified version of the said video. In some example implementations, a modified annotation that is derived from an annotation entered by a user is displayed during the said time interval of the said video or a modified version of the said video when the said video or the said modified version of the said video is played. The aforementioned “modified” version of the said shared video may include (but is not limited to) an edited version of the shared video, a video in which the brightness of the shared video is adjusted, a video in which additional video segments are added to the said shared video, or a video in which the noise voices of the shared video is removed.

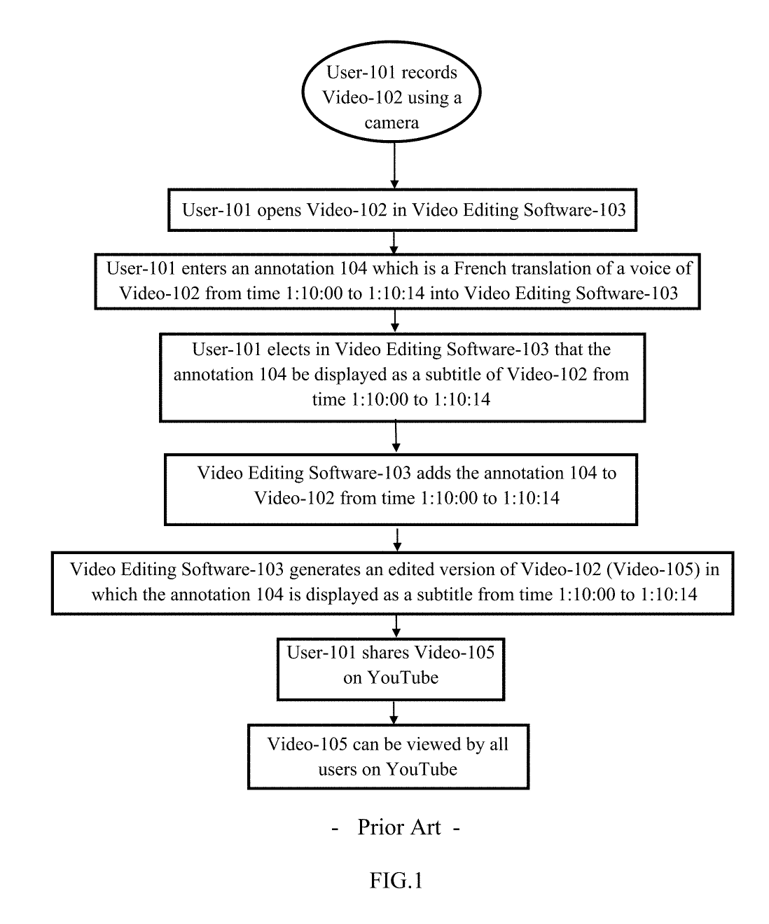

FIG. 1 shows a prior art where it depicts steps of a method in which a user can add an annotation to a video and share the resulting video with subtitle on YouTube. In this method, a user (User-101) records a video (Video-102) using a camera. User-101 then opens Video-102 in a video editing software (Video Editing Software-103). User-101 then enters an annotation 104 which is a French translation of a voice of Video-102 from time 1:10:00 to 1:10:14 into Video Editing Software-103. User-101 then elects in Video Editing Software-103 that the entered annotation 104 be displayed as a subtitle of Video-102 from time 1:10:00 to 1:10:14. The Video Editing Software-103 adds the entered annotation 104 to Video-102 from time 1:10:00 to 1:10:14 and generates an edited version of Video-102 (Video-105) in which the entered annotation 104 is displayed as a subtitle from time 1:10:00 to 1:10:14. User-101 then shares the Video-105 on YouTube and Video-105 can be viewed by all users of YouTube.

In the aforementioned prior art, the user who shares the video (User-101) knows the French language. Therefore, she is able to add annotation 104 in French. Hence, other users on YouTube who understand French are able to read the annotation. However, in situations that the user who initially shares the video does not understand French, she may not be able to add an annotation in French to her video before (or after) sharing it. The application of the present invention allows users on YouTube who understand French to add annotations in French to the video. Such annotation may be displayed as a subtitle of the shared video.

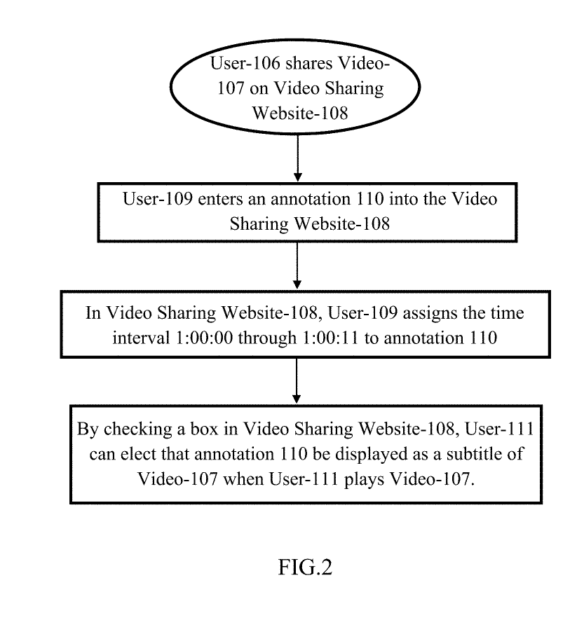

FIG. 2 shows an example implementation of the invention where it depicts steps of a method in which a user (User-106) shares a video (Video-107) on a video sharing website (Video Sharing Website-108) and another user (User-109) enters an annotation 110 into the Video Sharing Website-108. In Video Sharing Website-108, User-109 assigns the time interval 1:00:00 through 1:00:11 to the annotation 110. After User-109 assigned the time interval 1:00:00 through 1:00:11 to annotation 110, a user (User-111), by checking a box in Video Sharing Website-108, may elect that the said annotation 110 be displayed as a subtitle of Video-107 when User-111 plays video-107. In this case, annotation 110 is displayed as a subtitle of Video-107 from time 1:00:00 through 1:00:11 when User-111 plays Video-107. Still referring to FIG. 2, in some example implementations of the invention, if User-111 checks the said box, the annotation 110 is displayed in an area of a display other than the video area, instead of being displayed as a subtitle of Video-107 in the video area. In some example implementations, the said annotation 110 is a translation of a voice of the said video from time 1:00:00 through 1:00:11. In other example implementations, the said annotation 110 is a text of a voice of Video-107 from time 1:00:00 through 1:00:11.

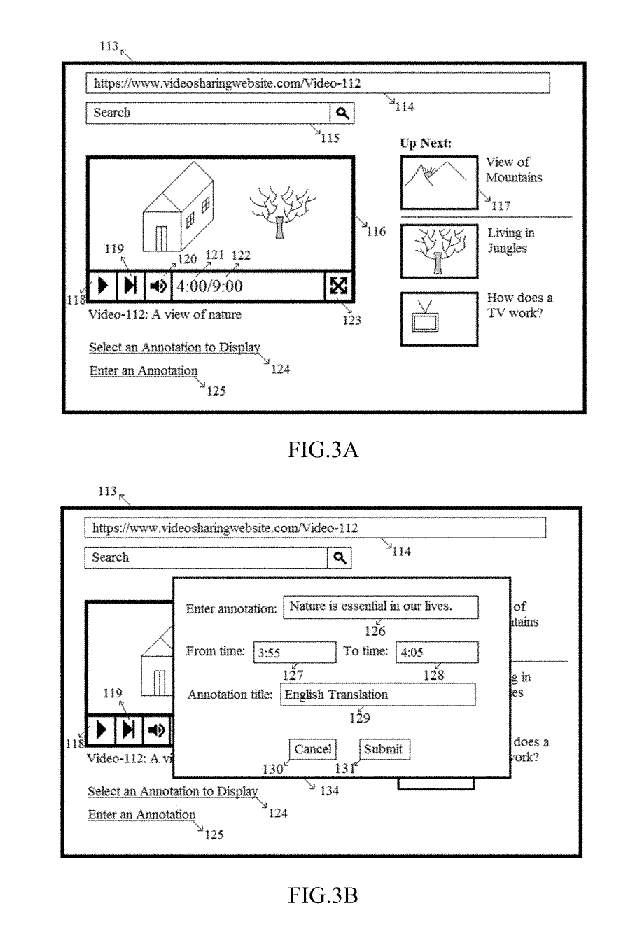

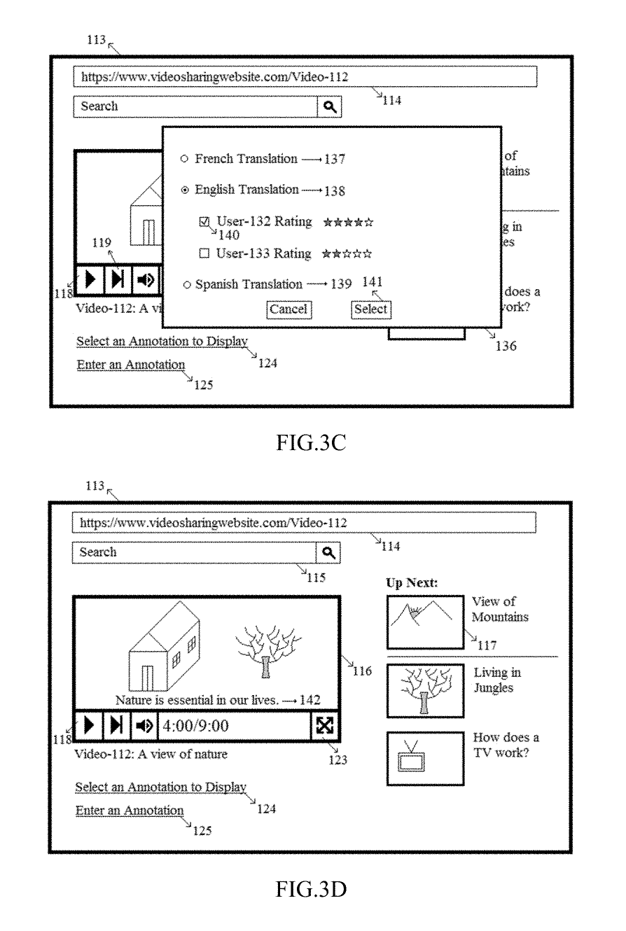

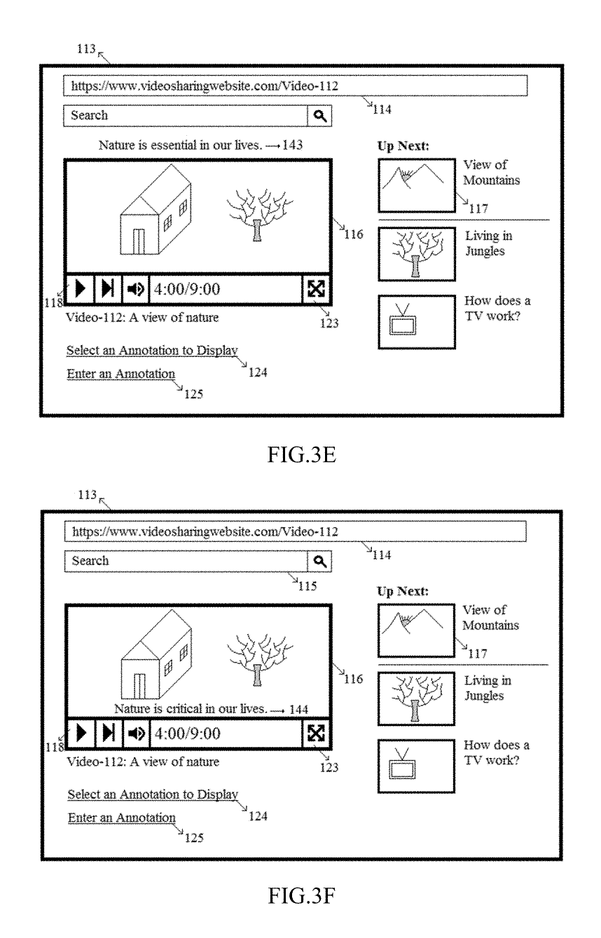

FIG. 3A, FIG. 3B, FIG. 3C, FIG. 3D, FIG. 3E, and FIG. 3F illustrate different views of an example implementation of the invention where they depict views of a method in which a user (User-134) shares a video (Video-112) on a video sharing website and another user (User-132) enters an annotation 126 into the said video sharing website and assigns a specific time interval (from 3:55 to 4:05 in this example) to annotation 126. FIG. 3A depicts a view of the said video sharing website in an internet browser window 113 as it is viewed by User-132. In FIG. 3A, 114 is the website address box, 115 is a search box, 116 is a window in which Video-112 is displayed, 117 is a video that will be automatically played after Video-112 is played up to its end, 118 is a play/pause button to play or pause the video in window 116, 119 is a button to stop the video of window 116 and to switch to a next video, 120 is a button to adjust the sound volume, 121 is the time of current frame of Video-112, 122 is the total length of Video-112, 123 is the full-screen button, 124 is a link in order to select an annotation to be displayed, and 125 is a link to enter an annotation. Once User-132 clicks on the link 125, window 134 pops up, as illustrated in FIG. 3B. In window 134, User-132 can enter an annotation 126 and assign a time interval from 127 through 128 to annotation 126. User-132 can enter an annotation title 129 and then assign the said time interval to annotation 126 by clicking on “Submit” button 131.

Referring to FIG. 3A, a user can elect to display or to not display a previously-entered annotation by clicking the link 124. If a user (User-135) clicks on the link 124, the window 136 pops up as it is illustrated in FIG. 3C. In some example implementations of the invention, User-135 can be the same User-132 or User-134. In window 136, User-135 can select among different annotation titles 137, 138, or 139. In some example implementations of the invention, annotation titles 137, 138, and 139 are the exact annotation titles entered by a user. In other example implementations, annotation titles 137, 138, or 139 are modified annotations that are derived from annotation titles entered by different users using a computer-implemented algorithm. For example, three different users may enter three annotation titles “english Translation”, “English Translation”, and “English sub-title” respectively. A computer-implemented algorithm may generate an annotation title 138 of “English Translation” from the said three annotation titles. In the example implementation shown in FIG. 3C, the annotation title 138 (“English Translation”) is same as the annotation title 129 entered by User-132 as shown in FIG. 3B.

Referring to FIG. 3C, User-135 selects annotation title 138, among annotation titles 137, 138, and 139. User-135 then selects the annotation entered by User-132 by checking the box 140. User-135 can then finalize the selection by clicking the button 141. After finalizing the selection by clicking button 141, annotation 126 is displayed as a subtitle 142 from time 127 through 128 of Video-112, when Video-112 is played by User-135 (FIG. 3D). In some example implementations of the invention, annotation 126 is displayed in an area 143 of a display other than the video window 116 from time 127 through 128 of Video-112 (See FIG. 3E).

Referring to FIG. 3F, in some example implementations of the invention, instead of the subtitle 142, a subtitle 144 that is a modified annotation derived from annotation 126 using a computer-implemented algorithm is displayed from time 127 through 128 of Video-112. For example, a computer-implemented algorithm may derive the annotation “Nature is critical in our lives.” from annotation 126, “Nature is essential in our lives.” The said annotation “Nature is critical in our lives.” is displayed as subtitle 144 from time 127 through 128 of Video-112 or a modified version of Video-112.

This application also discloses computer-implemented methods to share audios between users, wherein a first user shares an audio, wherein a second user or a computer-implemented algorithm enters an annotation, wherein the said second user or the said algorithm assigns a time interval to the said annotation or to a modified version of the said annotation. In some example implementations of the invention, the said annotation is a translation or a text of a voice of the said audio during the said time interval of the said audio or a modified version of the said audio.

In some example implementations, a user or a computer-implemented algorithm can elect to display or to not display the said annotation during an entire of a part of the said time interval of the said audio or a modified version of the said audio. In some example implementations, the said audio is a mp3 or a song.

This application also discloses computer-implemented methods to share videos between users, wherein a first user shares a video, wherein a second user or a computer-implemented algorithm enters a voice, wherein the said second user or the said algorithm assigns a time interval to the said voice or to a modified version of the said voice. In some example implementations of the invention, the said voice is a translation of a voice of the said video or a modified version of the said video during the said time interval of the said video or the said modified version of the said video. In some example implementations, a user or a computer-implemented algorithm can elect to play or to not play the said voice or a modified version of the said voice during a time interval of the said video or a modified version of the said video. In some example implementations, the said voice or a modified version of the said voice is mixed with another voice of the said video or a modified version of the said video during a time interval of the said video or the said modified version of the said video. In some example implementations, the said voice is a reading or a translation of a text displayed in the said video during the said time interval of the said video.

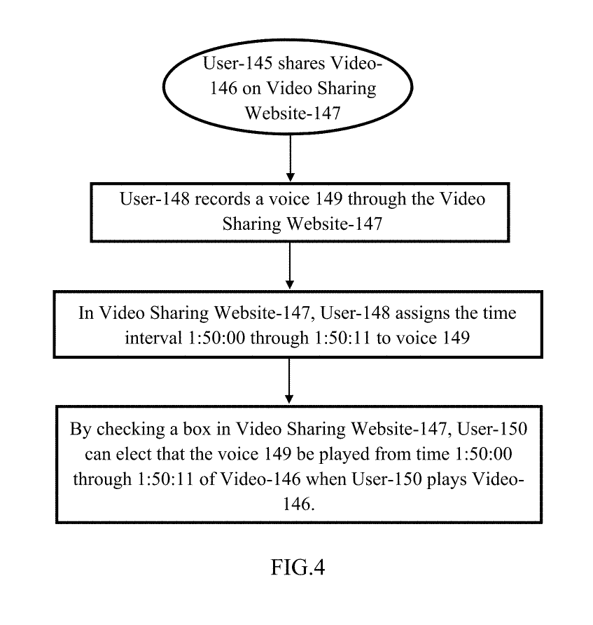

FIG. 4 shows an example implementation of the invention where it depicts steps of a method in which a user (User-145) shares a video (Video-146) on a video sharing website (Video Sharing Website-147) and another user (User-148) records a voice 149 through the Video Sharing Website-147. In Video Sharing Website-147, User-148 assigns the time interval 1:50:00 through 1:50:11 to voice 149. After User-148 assigned the time interval 1:50:00 through 1:50:11 to voice 149, a user (User-150), by checking a box in Video Sharing Website-147, may elect that the said voice 149 be played when User-150 plays video-146. In this case, voice 149 is played from time 1:50:00 through 1:50:11 of Video-146 when User-150 plays Video-146. Still referring to FIG. 4, in some example implementations of the invention, the said voice is mixed with another voice of Video-146 from time 1:50:00 through 1:50:11 of Video-146 when User-150 plays Video-146.

For the purpose of the present invention, the mentioned videos or audios in the preceding paragraphs may be shared on any computer-based platform such as internet, Local Area Networks (LANs), or any other computer-based network.

1. A computer-implemented method to share videos between users, wherein a first user shares a video, wherein a second user or a computer-implemented algorithm enters an annotation, wherein the said second user or the said algorithm assigns a time interval to the said annotation or to a modified version of the said annotation.

2. The method of claim 1, wherein the said annotation or a modified version of the said annotation is displayed as a sub-title of the said video or a modified version of the said video during an entire or a part of the said time interval of the said video or the said modified version of the said video.

3. The method of claim 1, wherein the said annotation or a modified version of the said annotation is displayed during a time interval of the said video or a modified version of the said video.

4. The method of claim 1, wherein the said annotation or a modified version of the said annotation is displayed in an area of a display other than the video area.

5. The method of claim 1, wherein the said annotation or the said modified version of the said annotation is a translation of a voice of the said video during an entire or a part of the said time interval of the said video or a modified version of the said video.

6. The method of claim 1, wherein the said annotation or the said modified version of the said annotation is a text of a voice of the said video or a modified version of the said video during an entire or a part of the said time interval of the said video or the said modified version of the said video.

7. The method of claim 1, wherein a user or a computer-implemented algorithm can elect to display or to not display the said annotation or a modified version of the said annotation when the said video or a modified version of the said video is played.

8. A computer-implemented method to share audios between users, wherein a first user shares an audio, wherein a second user or a computer-implemented algorithm enters an annotation, wherein the said second user or the said algorithm assigns a time interval to the said annotation or to a modified version of the said annotation.

9. The method of claim 8, wherein the said annotation or a modified version of the said annotation is displayed during an entire or a part of the said time interval of the said audio or a modified version of the said audio.

10. The method of claim 8, wherein the said annotation or a modified version of the said annotation is displayed during a time interval of the said audio or a modified version of the said audio.

11. The method of claim 8, wherein the said annotation or the said modified version of the said annotation is a translation of a voice of the said audio during an entire or a part of the said time interval of the said audio or a modified version of the said audio.

12. The method of claim 8, wherein a user or a computer-implemented algorithm can elect to display or to not display the said annotation or a modified version of the said annotation when the said audio or a modified version of the said audio is played.

13. The method of claim 8, wherein the said audio is a mp3 or a song.

14. A computer-implemented method to share videos between users, wherein a first user shares a video, wherein a second user or a computer-implemented algorithm enters a voice, wherein the said second user or the said algorithm assigns a time interval to the said voice or to a modified version of the said voice.

15. The method of claim 14, wherein the said voice or a modified version of the said voice is played during an entire or a part of the said time interval of the said video or a modified version of the said video.

16. The method of claim 14, wherein the said voice or a modified version of the said voice is played during a time interval of the said video or a modified version of the said video.

17. The method of claim 14, wherein the said voice or the said modified version of the said voice is a translation of a voice of the said video during an entire or a part of the said time interval of the said video or a modified version of the said video.

18. The method of claim 14, wherein a user or a computer-implemented algorithm can elect to play or to not play the said voice or a modified version of the said voice when the said video or a modified version of the said video is played.

19. The method of claim 14, wherein the said voice or a modified version of the said voice is mixed with another voice of the said video or a modified version of the said video during a time interval of the said video or the said modified version of the said video.

20. The method of claim 14, wherein the said voice or the said modified version of the said voice is a reading or a translation of a text displayed in the said video or in the modified version of the said video during an entire or a part of the said time interval of the said video or the said modified version of the said video.
